(19) United States
(12) Patent Application Publication
(10) Pub. No.: US 2023/0356082 A1
(43) Pub. Date: Nov. 9, 2023

(54) METHOD AND APPARATUS FOR DISPLAYING EVENT POP-UPS, DEVICE, MEDIUM AND PROGRAM PRODUCT

(71) Applicant: TENCENT TECHNOLOGY (SHENZHEN) COMPANY LIMITED, Shenzhen (CN)

(72) Inventors: Bowen TANG, Shenzhen (CN); Zhiliang ZHEN, Shenzhen (CN); Peng LIU, Shenzhen (CN); Ying TANG, Shenzhen (CN); Wen TANG, Shenzhen (CN); Mingyuan WU, Shenzhen (CN); Changming DENG, Shenzhen (CN)

(21) Appl. No.: 18/354,087

(22) Filed: Jul. 18, 2023

Related U.S. Application Data
(63) Continuation of application No. PCT/CN2022/126422, filed on Oct. 20, 2022.

(30) Foreign Application Priority Data
Nov. 24, 2021 (CN) 202111405452.4

(51) Int. Cl. A63F 13/533; A63F 13/79; A63F 13/537; A63F 13/86

(52) U.S. Cl. CPC A63F 13/533; A63F 13/79; A63F 13/537; A63F 13/86

(57) ABSTRACT

The present disclosure discloses a method and apparatus for displaying event pop-ups, a device, a medium and a program product, and relates to the technical field of computers. The method includes displaying an application interface in a target application, the target application having an association with a target event, the target application having a target account logged in; displaying an event pop-up in the application interface in response to the target event being in a livestreaming status, contestants of the target event comprising a target contestant; and displaying contestant information about the target contestant in the event pop-up, the target contestant having an interest association with the target account.

### RELATED APPLICATIONS

This application is a continuation of PCT Application No. PCT/CN2022/126422, filed on Oct. 20, 2022, which claims priority to Chinese Patent Application No. 202111405452.4, entitled “METHOD AND APPARATUS FOR DISPLAYING EVENT POP-UPS, DEVICE, MEDIUM AND PROGRAM PRODUCT” and filed on Nov. 24, 2021.

The two applications are both incorporated by reference in their entirety.

### FIELD OF THE TECHNOLOGY

This application relates to the technical field of computers, and in particular to a method and apparatus for displaying event pop-ups, a device, a medium and a program product.

### BACKGROUND OF THE DISCLOSURE

To promote the livestreaming of competitive events, event pop-ups are displayed in event-related applications or web pages to increase the viewing popularity of the event.

In e-sports events, the event pop-ups are used for displaying a preview live stream screen for livestreaming of the current event, and the pop-up interface corresponding to the event pop-up is decorated with a poster of the virtual role image designed by artists.

However, the posters used in the above-mentioned event pop-ups are uniformly designed, which are less relevant to the current live event and have less event-related information, making the pop-ups less efficient in delivering information.

### SUMMARY

Embodiments of this application provide a method and apparatus for displaying event pop-ups, a device, a medium and a program product, which can enhance the amount of information delivered about events. The technical solutions are as follows.

One aspect of this application provides a method for displaying event pop-ups, executed by a terminal. The method includes displaying an application interface in a target application, the target application having an association with a target event, the target application having a target account logged in; displaying an event pop-up in the application interface in response to the target event being in a livestreaming status, contestants of the target event comprising a target contestant; and displaying contestant information about the target contestant in the event pop-up, the target contestant having an interest association with the target account.

Another aspect of this application provides a computer device, the computer device including a processor and a memory, the memory storing at least one instruction, at least one program, and a code set or an instruction set, the at least one instruction, the at least one program, and the code set or the instruction set being loaded and executed by the processor to implement the method for displaying event pop-ups described in any one of the embodiments of this application.

In another aspect, a non-transitory computer-readable storage medium is provided, the computer-readable storage medium storing at least one program code, the program code being loaded and executed by a processor to implement the method for displaying event pop-ups described in any one of the embodiments of this application.

In embodiments consistent with the current disclosure, after the target account has logged into the target application, the event pop-up of the target event is displayed in the application interface of the target application. The event pop-up includes the contestant information of the contestant having an interest association with the target account, i.e., the display posters of the contestants in the event pop-up are displayed according to the interest of the target account, which enhances the amount of information delivered in the event pop-up and the efficiency of information delivery, and can enhance the interest of users in the target event, thus improving the stream guiding effect on the target event.

By displaying the information about the contestants in the current target event in the event pop-up, the related content of the target event can be displayed in the target application, improving the efficiency of data delivery and human-computer interaction for a user to understand certain procedures in the target event.

### BRIEF DESCRIPTION OF THE DRAWINGS

FIG. 1 is a schematic diagram of an e-sports event pop-up in a related technology of this application;

FIG. 2 is a schematic diagram of an implementation environment provided by an embodiment of this application;

FIG. 3 is a flowchart of a method for displaying event pop-ups provided by an embodiment of this application;

FIG. 4 is a flowchart of interface display of the event pop-up provided by an embodiment of this application;

FIG. 5 is a flowchart of a method for displaying event pop-ups provided by another embodiment of this application;

FIG. 6 is a schematic diagram of displaying the event pop-up when event data is empty provided by an embodiment of this application;

FIG. 7 is a schematic diagram of displaying the event pop-up when event data is not empty provided by an embodiment of this application;

FIG. 8 is a flowchart of a method for displaying event pop-ups provided by another embodiment of this application;

FIG. 9 is a structural block diagram of an apparatus for displaying event pop-ups provided by an embodiment of this application;

FIG. 10 is a structural block diagram of an apparatus for displaying event pop-ups provided by another embodiment of this application; and

FIG. 11 is a structural block diagram of a terminal provided by an embodiment of this application.

### DESCRIPTION OF EMBODIMENTS

First, nouns involved in embodiments of this application are briefly introduced.

Event pop-up: being a push window for promoting livestreaming of events, for guiding a stream to the livestreaming of events and boosting the popularity of the livestreaming of events. In some embodiments, the event may be a sports event, a music event, a debate event, an e-sports event, etc., without limitation in embodiments of this application. In some embodiments, the livestreaming of events is initiated through a livestreaming application, and the event pop-up is a pop-up displayed in an application interface of a target application, where the target application may be the livestreaming application or other programs associated with the target event corresponding to the livestreaming of events. In some embodiments, the livestreaming application may also be an applet with the target application as a host program.

In one example, taking an e-sports event as an example, the target application is implemented as a game application corresponding to the e-sports event. When a user has logged in the game application during the event, the event pop-up is displayed in the interface of the game application, and through the event pop-up, the interface can jump to the livestreaming room for the livestreaming of events so that the user can watch the event. In another example, taking a football event as an example, when a user has logged into a football-related application during the event (e.g.: Football Info application), an event pop-up may be displayed in an application interface. The above livestreaming room for the livestreaming of events can be a livestreaming room built in the above game application and information application or a livestreaming room in a livestreaming platform application distinct from the above game application and information application. In one example, the application displaying the event pop-up may also be the livestreaming platform application itself where the above livestreaming room is located. When the user has logged in the livestreaming platform application, a livestreaming home page is displayed and the above event pop-up is displayed on the livestreaming home page, and the interface can directly jump to the livestreaming room for the livestreaming of events through the above event pop-up for the user to view.

An e-sports event pop-up is as shown in FIG. 1. An event screen region 110 of an event pop-up 100 displays a preview live stream screen of the current target event. Virtual object images, pre-made by artists, in the game are respectively displayed in poster display regions 120 on both sides of the event screen region 110. The above virtual object images are uniformly set by the artists and will not change during the whole event.

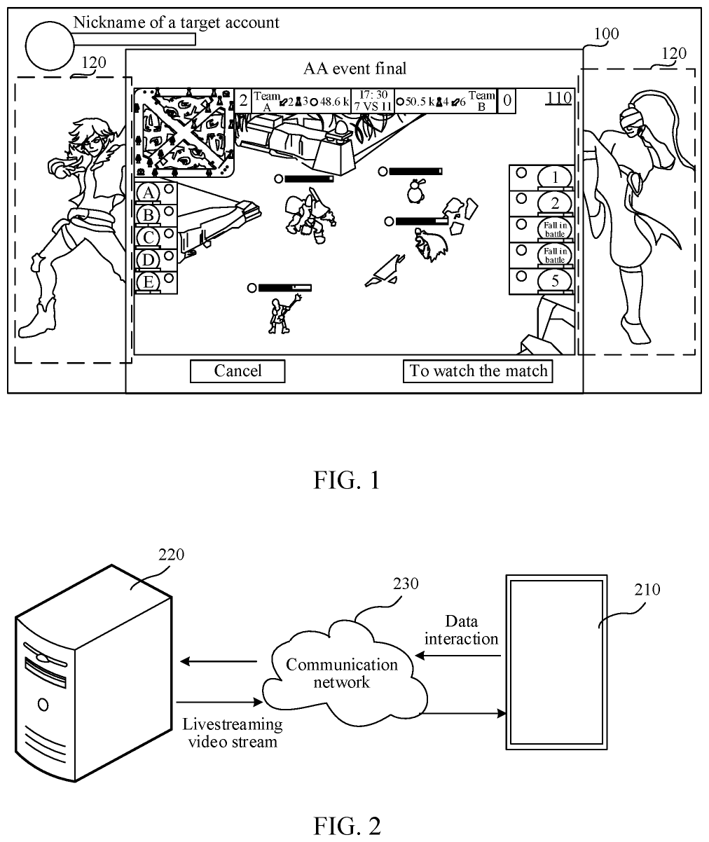

In conjunction with the above explanation of the terms, the implementation environment of some embodiments of this application are illustrated herewith. FIG. 2 shows a structural block diagram of a computer system provided by an embodiment of this application. The computer system includes a terminal device 210, a server 220 and a communication network 230.

A target application is installed and runs in terminal device 210. The target application may be any one of a Third-Person Shooting (TPS) game, a First-Person Shooting (FPS) game, a Multicontestant Online Battle Arena Games (MOBA), a Massive Multicontestant Online Role-Playing Game (MMORPG), a Multicontestant Shootout Survival Game, a Game Assistance Platform, a Live Streaming Platform and the like. The user makes the target application run via terminal device 210. In some embodiments, a livestreaming application is also installed in the terminal device 210, and the livestreaming application is used for the livestreaming of programs, e.g.: watching the livestreaming of events.

The terminal device 210 includes various forms of terminal devices such as mobile phones, tablet computers, desktop computers, portable laptops, etc.

The server 220 is used for providing data support for the generation of the event pop-up, and In some embodiments, the server 220 includes a target application service module and a service module for livestreaming of events. The target application service module is used for providing background support for the target application, for example, when the target application is a game application, the target application service module provides background game logic support for the target application running in the terminal device 210. The service module for livestreaming of events is used for providing background support for livestreaming of the target event, for example, the service module for livestreaming of events acquires the data stream of livestreaming of events from a live device of the target event and pushes same to a device with a target event livestreaming room turned on, or pushes the same to the terminal device 210 with the target application turned on and displaying the event pop-up.

In some embodiments, the server 220 undertakes primary computing work and the terminal device 210 undertakes secondary computing work; alternatively, the server 220 undertakes secondary computing work and the terminal device 210 undertakes primary computing work; alternatively, a distributed computing architecture is used for collaborative computing between the server 220 and the terminal device 210.

It is worth noting that the above-mentioned server 220 may be a stand-alone physical server, a cluster of servers or a distributed system composed of multiple physical servers, and may also be a cloud server providing cloud services, cloud databases, cloud computing, cloud functions, cloud storage, network services, cloud communication, middleware services, domain name services, security services, content delivery networks (CDN), big data and artificial intelligence platforms, and other basic cloud computing services. In some embodiments, server 220 may also be implemented as a node in a blockchain system.

In some embodiments of this application, when the terminal device 210 detects that the target account has logged in the target application, the livestreaming condition of the target event is acquired from the server 220, and when it is determined through the server 220 that the target event is in a livestreaming status, corresponding event pop-up data is acquired from the server 220, the event pop-up data includes the data stream of livestreaming of events and the competition situation of the target event, and the terminal device 210 generates and displays the event pop-up based on the above event pop-up data.

In some embodiments, the terminal device 210 and the server 220 are connected to each other via the communication network 230.

The information (including but not limited to user device information, user personal information, etc.), data (including but not limited to data used for analysis, stored data, displayed data, etc.) and signals involved in this application are all individually authorized by the user or fully authorized by various parties, and the collection, use and processing of relevant data need to comply with the relevant laws, regulations and standards of the relevant countries and regions. For example, the account data and livestreaming data involved in this application are acquired under full authorization.

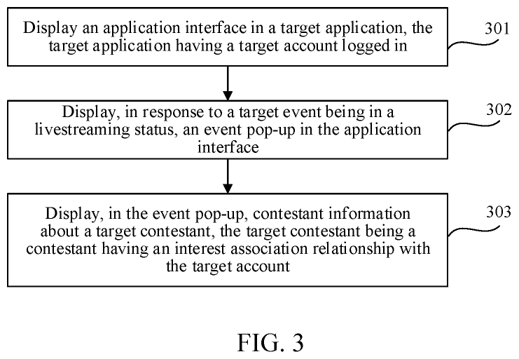

Reference is made to FIG. 3 which shows a method for displaying event pop-ups illustrated in an embodiment of this application. In some embodiments of this application, the method is applied to the terminal device as shown in FIG. 1. The method includes the following steps:

Step 301: Display an application interface in a target application, the target application having a target account logged in.

In some embodiments, the target application includes at least one of a game application, a game assistance application (e.g., a battle performance query application built outside the game application, etc.), a livestreaming application, a social application, a sports application, and other applications. In some embodiments, the above target account is a user account for logging in the target application.

In some embodiments, there is an association relationship between the target application and the target event. The association relationship between the target application and the target event includes the target event being a match completed through the target application, for example, the target application being a game application and the target event being an e-sports event completed through the game application; alternatively, the association relationship between the target application and the target event includes the event item of the target event being the application subject of the target application, for example, the target application being a basketball information application and the target event being a basketball event; alternatively, the association relationship between the target application and the target event includes the target application being a livestreaming application and the target application including a livestreaming room for the target event.

In some embodiments, the target event includes a sports event, a music event, a debate event, an e-sports event, etc., which is not limited herein.

In some embodiments of this application, an example that the target event is an e-sports event and the target application is a game application used by the e-sports event is schematically illustrated. The user can log in the target application through the terminal device, and after the terminal device completes account authentication and verification through a request server, an application interface is displayed, and the application interface is an interface for the target account to log in.

In some embodiments, the application interface may also be any interface in the target application, for example, the application interface is an interface corresponding to an activity module in the target application, or the application interface is an interface corresponding to a livestreaming platform in the target application, which is not limited by this embodiment.

Step 302: Display, in response to the target event being in a livestreaming status, the event pop-up in the application interface.

The event pop-up is used for displaying event-related information of the target event. The event-related information includes, but is not limited to, information related to the contestant, information related to the teams, stage data generated during the event, event result information, introduction information related to the event subject, etc., without limitation in this embodiment. The event pop-up is used for displaying the above event-related information, and in this embodiment, the event pop-up information includes information about the contestants.

The contestants of the target event include the target contestant.

The target event includes at least two teams participating in the competition. The at least two teams play at least one matchup in the target event, for example, if the target event is an e-sports event, the livestreaming content corresponding to the target event is a virtual matchup which at least two teams participate in.

Each team includes contestants participating in the target event. In some embodiments, the number of contestants in the teams may be the same, such as a 5V5 symmetrical competition, or the number of contestants in the teams may be different, such as a 1V3 asymmetrical competition, without limitation herein.

In some embodiments, after the terminal device displays the application interface which the target account has logged in, an event status request is sent to the server, the event status request is used for acquiring the event status of the target event, and whether the event pop-up corresponding to the target event needs to be displayed is determined according to the event status of the target event returned by the server.

In some embodiments, the above event status includes a non-event status, a livestreaming status and a non-livestreaming status. The above non-event status is used for indicating that the target event is not on or has ended; the livestreaming status is used for indicating that the target event is live, also representing that the target event is in progress; the non-livestreaming status is used for indicating that the target event has been on, but at the moment, it is not a match time or is not in the livestreaming progress.

In some embodiments, the event pop-up corresponding to the target event is displayed only when the target event is in the livestreaming status; alternatively, the event pop-up corresponding to the target event is displayed when the target event is in the livestreaming status or the non-livestreaming status, where when the target event is in the non-livestreaming status, content displayed in the event pop-up is replay content of the completed target event.

In some embodiments, the content displayed in the event pop-up includes livestreaming content of the target event. In some embodiments, the event pop-up includes an event screen region. The event screen region is being used for displaying a preview live stream screen of the target event. In some embodiments, there may be a difference in the content displayed by the preview live stream screen and a live stream screen of events in the livestreaming room of the event. For example, the preview live stream screen only displays a matchup screen and does not include at least one of matchup sounds, commentary sounds, bullet screen comment information, virtual resource consumption features and the like. Alternatively, there may be no difference in the content displayed by the preview live stream screen and the live stream screen of events in the livestreaming room of the event, without limitation herein.

An independent signal acquiring device (including at least one of audio and video) is set up at the site of the target event so that the above live stream screen is imported into a livestreaming instructor terminal (livestreaming instructor device or platform), then uploaded to the server via the network, and published to the corresponding livestreaming application or livestreaming web page through the server to be viewed by persons.

Step 303: Display, in the event pop-up, contestant information about the target contestant, the target contestant being a contestant having an interest association relationship with the target account.

In some embodiments, the event pop-up can be displayed immediately after the target account has logged in the target application, or can be displayed after the target account has logged in the target application and the target application has been running for a period of time, or, the event pop-up can also be displayed after the target account has logged in the target application and performs a specified operation in the target application, for example, the event pop-up is displayed on the selected livestreaming platform after the target account has logged in the target application, and is displayed after the livestreaming platform is opened. Embodiments of this application are not limited herein.

In some embodiments, a poster display region is included in the event pop-up, and the contestant information about the target contestant is displayed in the poster display region in the event pop-up.

In some embodiments, the display content of the event pop-up also includes the poster content of the target event, i.e., the content displayed in the poster display region. The poster display region may be located on the peripheral side of the event screen region, or at other locations in the application interface, forming the event pop-up together with the event screen region. The poster content is used for enhancing the attractiveness of a User Interface (UI) of the event pop-up and improving the interest of the user in the content of the pop-up.

In some embodiments, the contestants of at least two teams include the target contestant. In some embodiments, the number of the target contestant may be one or more. When the number of the target contestants is plural, the different target contestants may be from the same team or from different teams, without limitation herein.

In some embodiments, the above contestant information displayed in the poster display region includes at least one of contestant image information, contestant identification information, contestant team information, contestant duty information, role selection information, key event information, equipment selection information and the like.

The contestant image information includes a real/virtual image of the target contestant; the contestant identification information includes a real name or virtual nickname of the target contestant; the contestant team information includes a team identification (including a team name, a team Logo, etc.) of the team to which the target contestant belongs; the contestant duty information includes the position of duty of the target contestant in the target event, the position of duty is determined by the role which the contestant plays in the team, e.g., a striker, a midfielder, a defender and a goalkeeper in a football match, and a core position, an ancilla position, a jungle position, an opponent position, a middle road position, etc. in MOBA type e-sports; the role selection information includes the virtual role selection of the target contestant in historical event matchups or the virtual role selection of the target contestant in the current event matchup; the key event information includes key events of the target contestant in the historical event matchup or key events (highlight events) of the target contestant in the current event matchup, for example, when the above target event is a football match, the key event could be a key goal, a key goal interception, etc., and when the above target event is an e-sports match, the key event could be a key kill, number of kills, number of assisted kills, etc., and the key event is a certain spectacular action triggered or achieved by a contestant in an event matchup; the equipment selection information includes the virtual equipment configuration of the target contestant in the historical event matchup or the current event matchup.

In some embodiments, the above key event may be an event selected to be determined by a livestreaming person or a livestreaming instructor or may be an event determined by screen recognition performed on the live stream screen.

In some embodiments, the terminal device acquires historical account data of the target account, the historical account data including at least one of the condition of the historical matchups and historical settings of the target account, and based on the historical account data, the target contestant is determined among the contestants of the target event. It can be understood that the above historical account data of the target account, when the above embodiment of this application is applied to a specific product or technology, requires the permission or consent of the user, and the collection, use and processing of the relevant data need to comply with the relevant laws, regulations and standards of the relevant countries and regions.

In some embodiments, the interest association relationship existing between the target contestant and the target account includes at least one of the following relationships:
(i) the team duty corresponding to the target contestant includes the duty of interest of the target account.

The team duty corresponding to the target contestant includes the team duty in the target event, and the team duty corresponding to the target contestant is determined at the time when the target event is opened; the duty of interest of the target account includes the duty which the target account has held most often in the historical matchup, alternatively, the duty of interest of the target account includes the desired duty which has been selected most often in historical duty settings of the target account, the historical duty setting being the contestant preferred/desired duty set by the target account prior to participating in the historical matchup, which may or may not be the same as the duty really used in the historical matchup.
(ii) The virtual role selected by the target contestant in the target event includes the role of interest of the target account.

In some embodiments, the virtual role selected by the target contestant in the target event includes a virtual role selected by the target contestant in the historical event matchup of the target event, or a virtual role selected in the current event matchup of the target event. In one example, when no matchup data is generated for the current event matchup, i.e., the contestant has not made virtual role selection, the virtual role selected by the target contestant may be a virtual role selected by the target contestant in the historical event matchup of the target event; when matchup data is generated for the current event matchup, i.e., the contestant has made virtual role selection, the virtual role selected by the target contestant may be a virtual role selected in the current event matchup.

The role of interest of the target account includes the virtual role which the target account has selected for use most often in the historical matchup, alternatively, the role of interest of the target account includes the desired role which the target account has selected most often in the historical role setting, the historical role setting is a contestant preferred/desired role set by the target account prior to participating in the historical matchup, which may or may not be the same as the virtual role really used in the historical matchup.
(iii) The target contestant is a contestant who is pre-followed by the target account.

In some embodiments, the terminal device acquires attention or interaction data for the contestant in the target event by the target account from the target application or an associated application of the target application; similarly, the attention or interaction data requires the user's permission or consent when applied to specific products or technologies, and the collection, use and processing of the relevant data need to comply with the relevant laws, regulations and standards of the relevant countries and regions. The terminal device determines a contestant of interest corresponding to the target account in the target event as the target contestant based on the attention or interaction data. In one example, when the target application is a game application, the terminal device acquires a social application associated with the target application, acquires the contestants followed by the target account from the social application, and performs filtering on the contestants of the target event based on the followed contestant to obtain the target contestant.

In some embodiments, the event pop-up further includes a livestreaming room access control. In response to the livestreaming room access control on the event pop-up receiving a trigger operation, a livestreaming room interface of the event is displayed. The livestreaming room interface of the event is used for displaying the live stream screen of the target event. In some embodiments, the livestreaming room interface of the event may be an interface in the target application or an interface in other applications or web pages, without limitation herein.

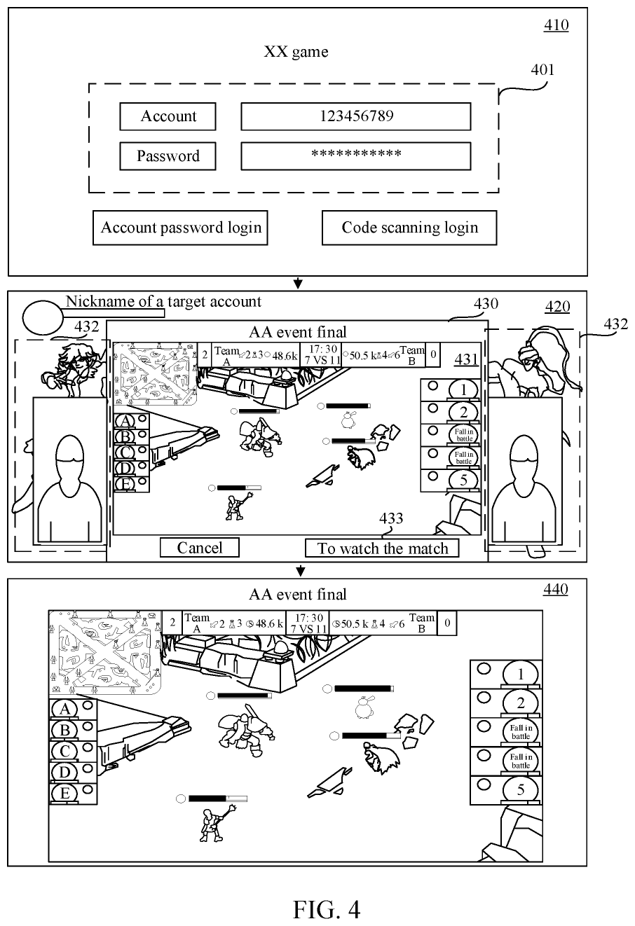

In one example, as shown in FIG. 4, a flowchart of interface display of an event pop-up provided by an embodiment of this application is illustrated. After logging in a target account 401 at a login interface 410 of the target application, when the terminal device and the server perform account verification and authentication, the terminal device displays an application interface 420 of the target application, and then displays an event pop-up 430 on the application interface 420. The event pop-up 430 includes an event screen region 431, poster display regions 432, and a livestreaming room access control 433. After the livestreaming room access control 433 receives a trigger operation, the terminal device jumps to display an event livestreaming room interface 440.

In summary, according to the method for displaying event pop-ups provided by an embodiment of this application, after the target account has logged in the target application, the event pop-up of the target event is displayed in the application interface of the target application, where the event pop-up includes the contestant information of the contestant having an interest association with the target account, i.e., the display posters of the contestants in the event pop-up are correspondingly displayed according to the interest of the target account, which enhances the amount of information delivered in the event pop-up and the efficiency of information delivery, and can enhance the interest of users in the target event, thus improving the stream guiding effect on the target event.

The method provided by some embodiments of this application determines the target contestant of interest corresponding to the target account by acquiring historical account data, so as to display the contestant information of the target contestant in the event pop-up, improving the accuracy rate of determining the target contestant and improving the attractiveness of the live stream to the target account.

The method provided by this embodiment determines the duty of interest of the target account based on team duty data generated by the target account in historical account data, thereby determining the target contestant corresponding to the duty of interest of the target account among a plurality of contestants, improving the accuracy for determining the target contestant and improving the attractiveness of the live stream to the target account.

The method provided by this embodiment determines the type of roles which the target account needs to know and learn based on role selection information generated by the target account in the historical account data, thereby determining the target contestant corresponding to the role of interest of the target account, displaying the contestant information of the target contestant in the event pop-up, and improving the efficiency of human-computer interaction and the effectiveness of data delivery.

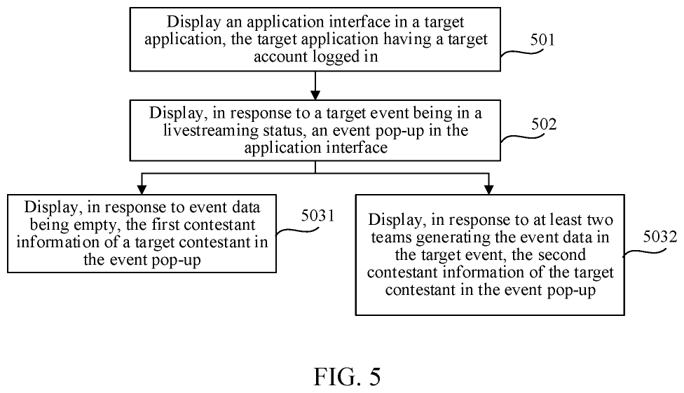

Reference is made to FIG. 5 which shows a method for displaying event pop-ups illustrated in an embodiment of this application. In some embodiments of this application, the case where no event data is generated for the current event matchup of the target event and the case where event data is generated for the current event matchup of the target event are illustrated, respectively. The method includes the following steps:

Step 501: Display an application interface in a target application, the target application having a target account logged in.

In some embodiments, the target application includes at least one of a game application, a game assistance application (e.g., a battle performance query application built outside the game application, etc.), a livestreaming application, a social application, a sports application, and other applications. The target application has the target account logged in.

In some embodiments, there is an association relationship between the target application and the target event. In some embodiments, the target event includes a sports event, a music event, a debate event, an e-sports event, etc., which is not limited herein.

Step 502: Display, in response to the target event being in a livestreaming status, the event pop-up in the application interface.

The event pop-up is used for displaying event-related information of the target event.

In some embodiments, in response to detecting that the target event is in the livestreaming status, acquiring team information about at least two teams participating in the target event and event data corresponding to the current event matchup; generating the event pop-up based on the team information and the event data; and displaying the event pop-up in the application interface. That is, in some embodiments of this application, when the target event is in the livestreaming status, the event pop-up is generated based on the team information of the teams participating in the target event and the event data of the teams corresponding to the current event matchup.

In some embodiments, the pop-up content corresponding to the event pop-up may be generated by the terminal device based on the acquired data, or may be generated by the server after requesting the server and may be directly acquired by the terminal device, without limitation herein.

Step 5031: Display, in response to the event data being empty, the first contestant information of the target contestant in the event pop-up.

The first contestant information includes an image identification of the target contestant and a team identification of the corresponding team. The target contestant is a contestant having an interest association relationship with the target account. In some embodiments of this application, when the event data is empty, the team duty corresponding to the target contestant includes the duty of interest of the target account, i.e., when no event data is generated for the current event matchup of the target event, the target contestant is determined based on the team duty of the contestant and the duty of interest of the target account, and the first contestant information corresponding to the target contestant is displayed.

The first contestant information may be in the form of text, or in the form of images, or in the form of a combination of text and images, without limitation herein.

In some embodiments, the historical account data acquired by the terminal device includes the team duty data of the target account in virtual matchup in which the target account has participated in the history, and the team duty data is used for recoding the duty selected by the target account in the virtual matchup. Determining, based on the team duty data in the historical account data, a target duty of interest of the target account, and determining a target contestant matching the target duty of interest from the at least two teams respectively.

The determining, based on the team duty data, a target duty of interest of the target account includes using the duty with the highest selection rate indicated by the team duty data as the target duty of interest of the target account; alternatively, using the desired duty set by the target account as indicated by the team duty data as the target duty of interest of the target account.

In some embodiments of this application, each team determines a target number of target contestants displayed in the event pop-up, in the case of the MOBA-type e-sports, the number of teams participating in the target event is two, the target number is one, and there are a total of two contestants displayed on the event pop-up, which represent different teams respectively.

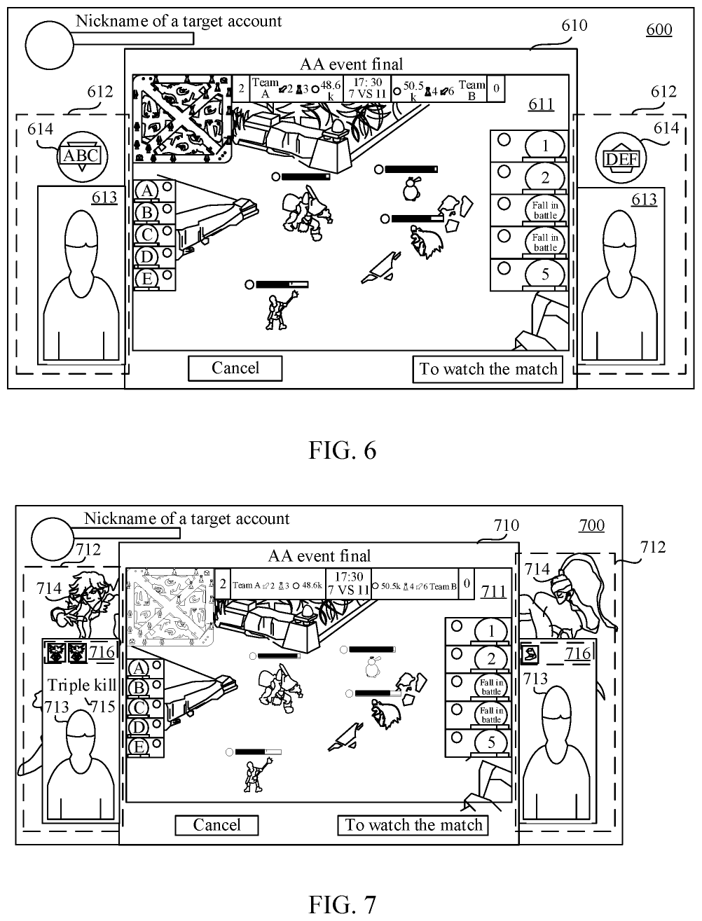

In one example, as shown in FIG. 6, a schematic diagram of displaying the event pop-up when event data is empty provided by an embodiment of this application is shown. An event pop-up 610 is displayed in an application interface 600. The event pop-up 610 includes an event screen region 611 and poster display regions 612. Since no event data is generated for the current event matchup, the poster display region 612 in the event pop-up 610 displays image information 613 of the target contestant and a team Logo 614 of the team of the target contestant.

Step 5032: Display, in response to at least two teams generating event data in the target event, the second contestant information of the target contestant in the event pop-up.

The second contestant information includes an image identification of the target contestant and event information corresponding to the target contestant, the event information being generated by the event data in the current event matchup, where the event information includes at least one of role selection information, equipment selection information, and key event information.

In some embodiments of this application, when the event data is not empty, the virtual role selected by the target contestant in the target event includes the role of interest of the target account, i.e., when the event data is generated in the current event matchup of the target event, the target contestant is determined based on the virtual role selected by the contestant in the current event matchup and the role of interest of the target account, and the second contestant information of the target contestant is displayed.

The second contestant information may be in the form of text, or in the form of images, or in the form of a combination of text and images, without limitation herein.

In some embodiments, the historical account data acquired by the terminal device includes role selection data of the target account in virtual matchups in which the target account has participated in the history, and the role selection data is used for recoding the virtual role controlled by the target account in the virtual matchup. By the terminal device, acquiring the role selection information of the contestants in at least two teams, and determining, based on the role selection data and the role selection information of the contestants, the target contestant from the contestants in at least two teams respectively, each team corresponding to a target number of target contestants.

The determining, based on the role selection data and the role selection information of the contestants, the target contestant includes: sorting the virtual roles selected for the contestants in the at least two teams respectively based on the role selection frequency in the role selection data to obtain the role order corresponding to the at least two teams respectively; and determining, based on the role order, the target contestant corresponding to the team from the at least two teams. For example, the teams include team 1 and team 2, where contestant A in team 1 selects virtual role A, contestant B selects virtual role B, contestant C selects virtual role C and contestant F selects virtual role F. The order of the roles of team 1 obtained by the virtual roles A to C based on the level of interest of the target account (e.g.: according to the role selection frequency of the target account in the historical role selection data) is virtual role C, virtual role B, and virtual role A, then the target contestant determined corresponding to team 1 is contestant C, and in the same way, the target contestant is determined from team 2.

In some embodiments of this application, each team determines a target number of target contestants displayed in the event pop-up, in the case of the MOBA-type e-sports, the number of teams participating in the target event is two, the target number is one, and there are a total of two contestants displayed on the event pop-up, which represent different teams respectively.

In one example, as shown in FIG. 7, a schematic diagram of displaying the event pop-up when event data is not empty provided by an embodiment of this application is shown. The event pop-up 710 is displayed in application interface 700. The event pop-up 710 includes an event screen region 711 and poster display regions 712. Since no event data is generated for the current event matchup, the poster display region 712 in the event pop-up 710 displays image information 713 of the target contestant and role information 714 of virtual roles selected by the target contestant, key event information 715 and equipment selection information 716.

In summary, according to the method for displaying event pop-ups provided by an embodiment of this application, after the target account has logged in the target application, the event pop-up of the target event is displayed in the application interface of the target application, where the event pop-up includes the contestant information of the contestant having an interest association with the target account, i.e., the display posters of the contestants in the event pop-up are correspondingly displayed according to the interest of the target account, which enhances the amount of information delivered in the event pop-up and the efficiency of information delivery, and can enhance the interest of users in the target event, thus improving the stream guiding effect on the target event.

In some embodiments of this application, different contestant information is displayed according to the progress of the event matchup in the target event, in order to give different solutions for whether the event data is generated or not, i.e., when no event data is generated for the current event matchup, the first contestant information of the target contestant is displayed according to the duty selection of the contestant, and when the event data is generated for the current event matchup, the second contestant information of the target contestant is displayed according to the virtual role selection of the contestant, and the corresponding contestant information is displayed according to the interest of the target account in different situations, in order to combine the event data and user information in a more real-time and effective manner to be present to the user through the automatically assembled pop-up, which is more effective in enhancing the interest of the user in the livestreaming content of the event and the willingness of the user to watch the event.

In some embodiments of this application, the matched display of the event pop-up is achieved by acquiring the team information of multiple teams in the target event, as well as the event data, so as to improve the display flexibility of the event pop-up.

In some embodiments of this application, in the process of selecting the target contestant, the roles selected in the plurality of teams are sorted according to the comparison of the selection frequency of each role in the role selection data of the target account, and the target contestant is selected according to the role sorting, which improves the accuracy rate of hitting the level of interest of the target contestant.

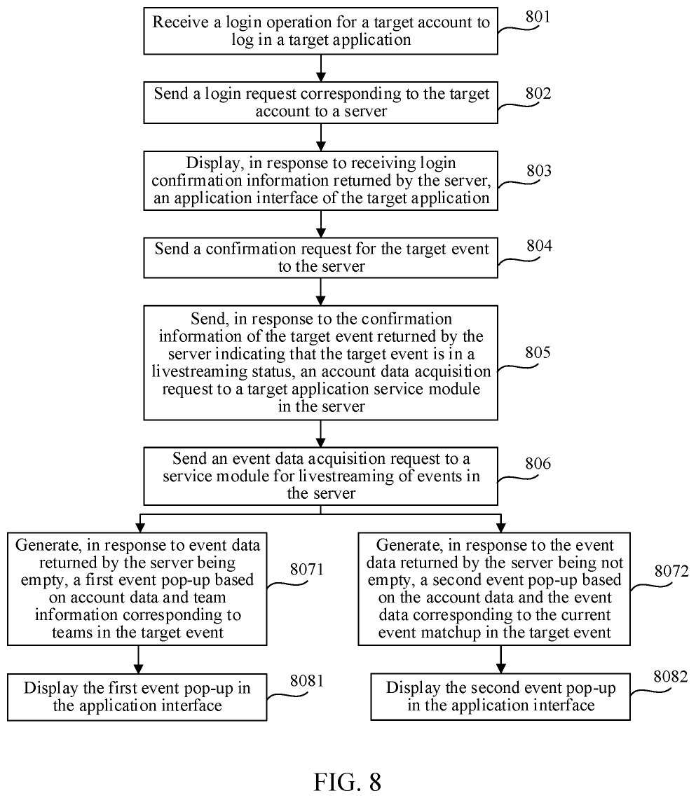

Reference is made to FIG. 8 which shows a method for displaying event pop-ups illustrated in an embodiment of this application. In some embodiments of this application, the data stream of the method is In some embodiments illustrated. The method includes the following steps:

Step 801: Receive a login operation for a target account to log into a target application.

In some embodiments, a device interface of a terminal device includes a launch icon corresponding to the target application. When the launch icon receives a trigger operation, a login interface of the target application is displayed, and the login operation for the target account is received in the login interface.

Step 802: Send a login request corresponding to the target account to a server.

The above login request includes an account identification and verification information (account password) of the target account for the server to perform authentication and verification based on the correspondence of the account identification and the verification information.

Step 803: Display, in response to receiving login confirmation information returned by the server, an application interface of the target application.

When the server, based on the received login request, compares the account identification and verification information in the login request with an account identification and verification information stored in the server, the login confirmation information is returned to the terminal device when it is determined that the account identification and the verification information are corresponding.

After receiving the above login confirmation information, the terminal device displays the application interface of the target application, and the application interface corresponds to the target account.

Step 804: Send a confirmation request for the target event to the server.

The confirmation request is for confirming the event status of the target event via the server. The above event status includes a non-event status, a livestreaming status and a non-livestreaming status. The above non-event status is used for indicating that the target event is not on or has ended; the livestreaming status is used for indicating that the target event is live, also representing that the target event is in progress; the non-livestreaming status is used for indicating that the target event has been on, but at the moment, it is not a match time.

In some embodiments, the server includes a target application service module and a service module for livestreaming of events, where the target application service module is used for providing background support for the target application, for example, when the target application is a game application, the target application service module provides background game logic support for the target application running in the terminal device. The service module for livestreaming of events is used for providing background support for livestreaming of the target event, for example, the service module for livestreaming of events acquires the data stream of livestreaming of events from a live device of the target event and pushes same to a device with a target event livestreaming room turned on, or pushes the same to the terminal device with the target application turned on and displaying the event pop-up.

Step 805: Send, in response to the confirmation information of the target event returned by the server indicating that the target event is in a livestreaming status, an account data acquisition request to the target application service module in the server.

The above account data acquisition request is sent to the server by the terminal device after acquiring permission or consent from the user.

In some embodiments, the server, after receiving the account data acquisition request sent by the terminal device, acquires historical account data corresponding to the target account from a database, the historical account data including at least one of the condition of the historical matchups and historical settings of the target account.

Step 806: Send the event data acquisition request to the service module for livestreaming of events on the server.

In some embodiments, after the server receives the event data acquisition request sent by the terminal device, the service module for livestreaming of events performs processing, and the service module for livestreaming of events acquires team information of the teams in the target event and event data of the current event matchup, where the returned event data is empty when no event data is generated for the current event matchup.

In some embodiments, the event data includes log data of the target event acquired from the event service, the log data includes the matchup progress of the current event matchup of the target event, virtual role selection data of the contestants, duty configuration data of the contestants, equipment selection data of the contestant, matchup data of the contestants, such as, key event data, Kill Death Assist (KDA) data, etc.

Step 8071: Generate, in response to the event data returned by the server being empty, a first event pop-up based on the account data and the team information corresponding to the teams in the target event.

In some embodiments, when the event data is empty, this means that the current event matchup is not yet in a matchup stage, for example, the current event matchup is in a preparation stage, or the current event matchup has not yet started and is in a data aggregation stage after the previous event matchup has ended.

In this case, the contestants having an interest association relationship with the target account are determined separately from the teams of the target event based on the duty of interest of the target account, e.g., the contestant in the team, of which the duty is the duty of interest of the target account is determined as the target contestant, and the first event pop-up is generated according to the image information of the target contestant and the team logo of the team corresponding to the target contestant.

Step 8072: Generate, in response to the event data returned by the server being not empty, a second event pop-up based on the account data and the event data corresponding to the current event matchup in the target event.

The event data is generated after the current event matchup enters the matchup stage, and the server returns the event data corresponding to the current event matchup in the target event at the current moment to the terminal device.

In this case, the contestants having an interest association relation with the target account are separately determined from the teams of the target event based on the role of interest of the target account, for example, the virtual roles selected by each contestant in the teams are sorted according to the interest level of the target account, and the contestant corresponding to the virtual role with the highest interest level is determined as the target contestant, and the second event pop-up is generated based on the image information of the target contestant and the event data of the target contestant in the current event matchup.

Step 8081: Display the first event pop-up in the application interface.

In some embodiments, the first event pop-up also includes an event screen region. In the event screen region, a preview live stream screen of the target event is displayed. In some embodiments, when the event data is empty, i.e., the current event matchup is not yet in the matchup stage, the event screen region may also be used for displaying score information corresponding to the currently ended event matchup, alternatively, to display a wait time to move to the next event matchup, alternatively, to display a matchup replay screen for the currently ended event matchup.

First contestant information including an image logo of the target contestant and a team logo of a corresponding team is displayed in the poster display region on the peripheral side of the event screen region.

Step 8082: Display the second event pop-up in the application interface.

In some embodiments, the preview live stream screen of the target event is displayed in the second event pop-up.

In some embodiments, the second event pop-up further includes an event screen region. In the event screen region, the preview live stream screen of the target event is displayed. In some embodiments, there may be a difference in the content displayed by the preview live stream screen and a live stream screen of events in the livestreaming room of the event. For example, the preview live stream screen only displays a matchup screen and does not include at least one of matchup sounds, commentary sounds, bullet screen comment information, virtual resource consumption features and the like. Alternatively, there may be no difference in the content displayed by the preview live stream screen and the live stream screen of events in the livestreaming room of the event, without limitation herein.

The second contestant information including an image logo of the target contestant and the event information corresponding to the target contestant is displayed in the poster display region on the peripheral side of the event screen region.

In some embodiments, the process of generating the first event pop-up or the second event pop-up can also be implemented in the server, i.e., the server generates the first event pop-up or the second event pop-up and then returns the first event pop-up or the second event pop-up to the terminal device.

In some embodiments, in addition to returning the account data and the event data to the terminal, the server also pushes a video stream of livestreaming of the target event to the terminal device, and the terminal device decodes the video stream and displays same in the event screen region of the first event pop-up or the second event pop-up.

In some embodiments of this application, different contestant information is displayed according to the progress of the event matchup in the target event, in order to give different solutions for whether the event data is generated or not, i.e., when no event data is generated for the current event matchup, the first contestant information of the target contestant is displayed according to the duty selection of the contestant, and when the event data is generated for the current event matchup, the second contestant information of the target contestant is displayed according to the virtual role selection of the contestant, and the corresponding contestant information is displayed according to the interest of the target account in different situations, which is able to further enhance the interest of the user in the target event.

In some embodiments of this application, the display process of the event pop-up is implemented by the terminal device and the server in collaboration, and data processing is carried out by a distributed architecture, which enhances the data processing efficiency.

In some embodiments of this application, by displaying the preview live stream screen of the target event in the event pop-up, the attractiveness of the livestreaming of the event to the target account is improved and the efficiency of information delivery is enhanced.

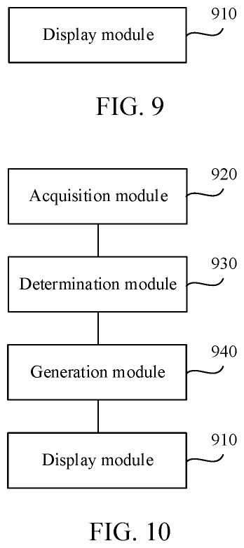

Reference is made to FIG. 9 which shows a structural block diagram of an apparatus for displaying event pop-ups provided by an embodiment of this application. The apparatus includes the following modules:
a display module 910, configured to display an application interface in a target application, the target application having an association relationship with a target event, the target application having a target account logged in;
the display module 910 being further configured to display, in response to the target event being in a livestreaming status, the event pop-up in the application interface, the target event including a target contestant; and

display module 910 being further configured to display, in the event pop-up, contestant information about the target contestant, the target contestant being a contestant having an interest association relationship with the target account.

In some embodiments, as shown in FIG. 10, the apparatus further includes:
an acquisition module 920, configured to acquire historical account data of the target account, the historical account data being used for indicating a historical matchup of the target account; and
a determination module 930, configured to determine the target contestant from the contestants of the target event based on the historical account data.

In some embodiments, the historical account data includes team duty data of the target account in a virtual matchup in which the target account has participated in the history, the team duty data being used for recording a duty selected by the target account in the virtual matchup, the target event including at least two teams;
the determination module 930 is further configured to determine a target duty of interest of the target account based on the team duty data in the historical account data; and
the determination module 930 is further configured to determine the target contestant matching the target duty of interest from the at least two teams respectively.

In some embodiments, the determination module 930 is further configured to use the duty with the highest selection rate as indicated by the team duty data as the target duty of interest of the target account; alternatively, use the desired duty set by the target account as indicated by the team duty data as the target duty of interest of the target account.

In some embodiments, the historical account data includes role selection data of the target account in the virtual matchups in which the target account has participated in the history, the role selection data being used for recording the virtual roles controlled by the target account in the virtual matchup, the target event including at least two teams;
the acquisition module 920 is further configured to acquire role selection information of the contestants in the at least two teams;
the determination module 930 is further configured to determine the target contestant from the contestants of the at least two teams based on the role selection data and role selection information of the contestant, respectively.

In some optional embodiment, the determination module 930 is further configured to sort the virtual roles selected for the contestants in the at least two teams based on the role selection frequency in the role selection data, respectively, to obtain the role order corresponding to the at least two teams, respectively;
the determination module 930 is further configured to determine, based on the role order, the target contestant corresponding to the team from at least two teams.

In some embodiments, the acquisition module 920 is further configured to acquire, in response to detecting that the target event is in a livestreaming status, team information of at least two teams participating in the target event and event data corresponding to the current event matchup;
the apparatus further includes:
a generation module 940, configured to generate the event pop-up based on the team information and the event data,
the display module 910 being further configured to display the event pop-up in the application interface.

In some embodiments, the display module 910 is further configured to display, in response to the event data being empty, first contestant information of the target contestant in the poster display region in the event pop-up, the first contestant information including an image identification of the target contestant and a team logo of the corresponding team.

In some embodiments, the display module 910 is further configured to display, in response to the at least two teams having generated the event data in the target event, the second contestant information of the target contestant in the event pop-up, the second contestant information including an image identification of the target contestant and event information corresponding to the target contestant, the event information being generated by the event data, the event information including at least one of role selection information, equipment selection information, and key event information.

In some embodiments, the display module 910 is further configured to display a preview live screen of the target event in the event pop-up.

In some embodiments, the display module 910 is further configured to display, in response to a livestreaming room entry control on the event pop-up receiving a trigger operation, a livestreaming room interface of the event, the livestreaming room interface of the event being used for displaying a live stream screen of the target event.

In summary, according to the apparatus for displaying event pop-ups provided by an embodiment of this application, after the target account has logged in the target application, the event pop-up of the target event is displayed in the application interface of the target application, where the event pop-up includes the contestant information of the contestant having an interest association with the target account, i.e., the display posters of the contestants in the event pop-up are correspondingly displayed according to the interest of the target account, which enhances the amount of information delivered in the event pop-up and the efficiency of information delivery, and can enhance the interest of users in the target event, thus improving the stream guiding effect on the target event.

The apparatus for displaying event pop-ups provided by the above embodiment is illustrated with an example of division of the foregoing functional modules. In practical applications, the foregoing functions may be allocated to be completed by different functional modules according to requirements, that is, the internal structure of the device is divided into different functional modules, so as to complete all or part of the functions described above. In addition, the embodiments of the apparatus for displaying event pop-ups and the method for displaying event pop-ups provided by the above embodiments are based on the same concept. For the specific implementation process, refer to the method embodiments, and the details are not described herein again.

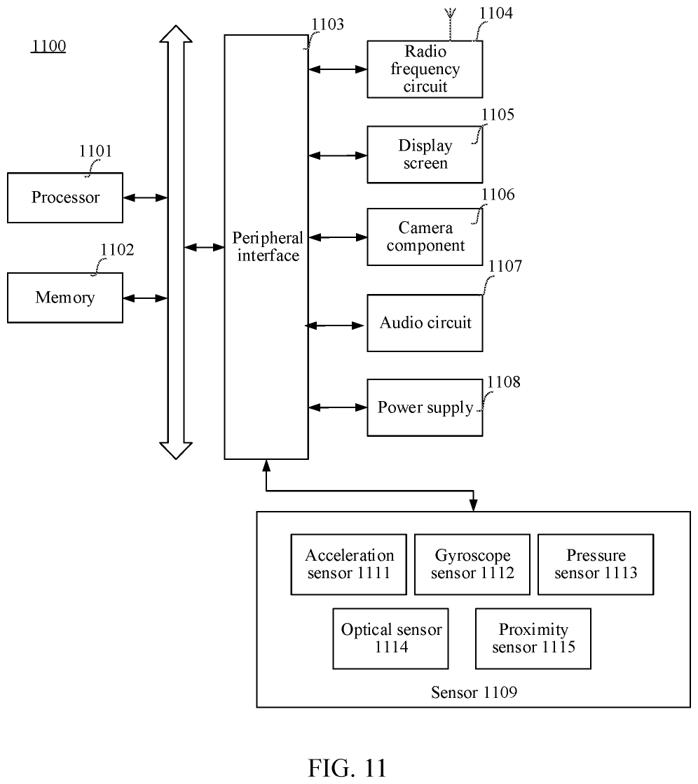

FIG. 11 shows a structural block diagram of a terminal 1100 provided by an embodiment of this application. The terminal 1100 may be a smartphone, a tablet computer, a Moving Picture Experts Group Audio Layer III (MP3), a Moving Picture Experts Group Audio Layer IV (MP4), a notebook computer, or a desktop computer. The terminal 1100 may also be referred to as another name such as user equipment, a portable terminal, a laptop terminal, or a desktop terminal.

Usually, terminal 1100 includes: a processor 1101 and a memory 1102.

The processor 1101 may include one or more processing cores, for example, a 4-core processor or an 8-core processor. The processor 1101 may be implemented in at least one hardware form of digital signal processing (DSP), a field-programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process the data in a standby state. In some embodiments, processor 1101 may be integrated with a graphics processing unit (GPU). The GPU is configured to render and draw content that needs to be displayed on a display screen. In some embodiments, processor 1101 may further include an artificial intelligence (AI) processor. The AI processor is configured to process computing operations related to machine learning.

Memory 1102 may include one or more computer-readable storage mediums. The computer-readable storage medium may be non-transient. Memory 1102 may further include a high-speed random access memory and a nonvolatile memory, for example, one or more disk storage devices or flash storage devices. In some embodiments, the non-transient computer-readable storage medium in the memory 1102 is configured to store at least one instruction, the at least one instruction being configured to be executed by the processor 1101 to implement the control method based on virtual matchups provided in the method embodiments of this application.

In some embodiments, the terminal 1100 further may In some embodiments include: a peripheral interface 1103 and at least one peripheral. Processor 1101, the memory 1102, and the peripheral interface 1103 may be connected through a bus or a signal line. Each peripheral may be connected to the peripheral interface 1103 through a bus, a signal line, or a circuit board. Specifically, the peripheral includes at least one of a radio frequency circuit 1104, a display screen 1105, a camera component 1106, an audio circuit 1107 and a power supply 1108.

In some embodiments, the terminal 1100 further may include one or more sensors 1109. The one or more sensors 1109 include, but are not limited to, an acceleration sensor 1111, a gyroscope sensor 1112, a pressure sensor 1113, an optical sensor 1114, and a proximity sensor 1115.

A person skilled in the art may understand that the structure shown in FIG. 11 constitutes no limitation on the terminal 1100, and the terminal may include more or fewer components than those shown in the figure, or some components may be combined, or a different component deployment may be used.

A person of ordinary skill in the art may understand that all or some of the steps of the various methods in the above embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and is not assembled in a terminal. The computer-readable storage medium stores at least one instruction, at least one program, a code set, or an instruction set. At least one instruction, the at least one program, the code set, or the instruction set is loaded or executed by the processor to implement the control method based on virtual matchups according to any one of the foregoing embodiments.

What is claimed is:

1. A method for displaying event pop-ups, executed by a terminal, the method comprising:
displaying an application interface in a target application, the target application having an association with a target event, the target application having a target account logged in;
displaying an event pop-up in the application interface in response to the target event being in a livestreaming status, contestants of the target event comprising a target contestant; and
displaying contestant information about the target contestant in the event pop-up, the target contestant having an interest association with the target account.

2. The method according to claim 1, before the displaying contestant information about the target contestant in the event pop-up, further comprising:
acquiring historical account data of the target account, the historical account data indicating a historical matchup of the target account; and
determining the target contestant from the contestants of the target event based on the historical account data.

3. The method according to claim 2, the historical account data comprises team duty data of the target account in a virtual matchup in which the target account has participated, the team duty data recording a duty selected by the target account in the virtual matchup, the target event comprising at least two teams;
the determining the target contestant from the contestants of the target event based on the historical account data comprises:
determining a target duty of interest of the target account based on the team duty data in the historical account data; and
determining the target contestant matching the target duty of interest from the at least two teams respectively.

4. The method according to claim 3, the determining a target duty of interest of the target account based on the team duty data in the historical account data comprises:
using the duty with a highest selection rate as indicated by the team duty data as the target duty of interest of the target account;
alternatively,
using a desired duty set by the target account as indicated by the team duty data as the target duty of interest of the target account.

5. The method according to claim 2, the historical account data comprises role selection data of the target account in a virtual matchup in which the target account has participated, the role selection data recording a virtual role controlled by the target account in the virtual matchup, the target event comprising at least two teams; and
the determining the target contestant from the contestants of the target event based on the historical account data comprises:
acquiring role selection information of the contestants in the at least two teams; and
determining the target contestant from the contestants of the at least two teams respectively based on the role selection data and the role selection information of the contestant.

6. The method according to claim 5, the determining the target contestant from the contestants of the at least two teams respectively based on the role selection data and the role selection information of the contestant comprises:
sorting virtual roles selected for the contestants in the at least two teams respectively based on a role selection frequency in the role selection data to obtain a role order corresponding to the at least two teams respectively; and
determining the target contestant corresponding to the team from the at least two teams based on the role order.

7. The method according to claim 1, wherein the displaying, in response to the target event being in a livestreaming status, an event pop-up in the application interface comprises:
acquiring team information about at least two teams participating in the target event in response to detecting that the target event is in the livestreaming status, and event data corresponding to the current event matchup; and
generating the event pop-up based on the team information and the event data; and
displaying the event pop-up in the application interface.

8. The method according to claim 7, wherein the displaying contestant information about the target contestant in the event pop-up comprises:
displaying first contestant information of the target contestant in the event pop-up in response to the event data being empty, the first contestant information comprising an image identification of the target contestant and a team logo of the corresponding team of the target contestant.

9. The method according to claim 7, wherein the displaying contestant information about the target contestant in the event pop-up comprises:
displaying, in response to the at least two teams generating the event data in the target event, second contestant information of the target contestant in the event pop-up, the second contestant information comprising an image identification of the target contestant and event information corresponding to the target contestant, the event information being generated by the event data, the event information comprising at least one of role selection information, equipment selection information, and key event information.

10. The method according to claim 1, wherein the method further comprises:
displaying a preview live stream screen of the target event in the event pop-up.

11. The method according to claim 1, wherein after the displaying, contestant information about the target contestant in the event pop-up, the method further comprises:
displaying, in response to a livestreaming room entry control on the event pop-up receiving a trigger operation, a livestreaming room interface of the event, the livestreaming room interface of the event displaying a live stream screen of the target event.

12. A computer device, the computer device comprising a processor and a memory, the memory storing at least one instruction, at least one program, and a code set or an instruction set, the at least one instruction, the at least one program, and the code set or the instruction set being loaded and executed by the processor to implement a method for displaying event pop-ups, the method comprising:
displaying an application interface in a target application, the target application having an association with a target event, the target application having a target account logged in;
displaying an event pop-up in the application interface in response to the target event being in a livestreaming status, contestants of the target event comprising a target contestant; and
displaying contestant information about the target contestant in the event pop-up, the target contestant having an interest association with the target account.

13. The computer device according to claim 12, before the displaying contestant information about the target contestant in the event pop-up, the method further comprising:
acquiring historical account data of the target account, the historical account data indicating a historical matchup of the target account; and
determining the target contestant from the contestants of the target event based on the historical account data.

14. The computer device according to claim 13, wherein the historical account data comprises team duty data of the target account in a virtual matchup in which the target account has participated, the team duty data recording a duty selected by the target account in the virtual matchup, the target event comprising at least two teams;
the determining the target contestant from the contestants of the target event based on the historical account data comprises:
determining a target duty of interest of the target account based on the team duty data in the historical account data; and
determining the target contestant matching the target duty of interest from the at least two teams respectively.

15. The computer device according to claim 14, wherein the determining a target duty of interest of the target account based on the team duty data in the historical account data comprises:
using the duty with a highest selection rate as indicated by the team duty data as the target duty of interest of the target account;
alternatively,
using a desired duty set by the target account as indicated by the team duty data as the target duty of interest of the target account.

16. The computer device according to claim 13, wherein the historical account data comprises role selection data of the target account in a virtual matchup in which the target account has participated, the role selection data recording a virtual role controlled by the target account in the virtual matchup, the target event comprising at least two teams; and
the determining the target contestant from the contestants of the target event based on the historical account data comprises:
acquiring role selection information of the contestants in the at least two teams; and
determining the target contestant from the contestants of the at least two teams respectively based on the role selection data and the role selection information of the contestant.

17. The computer device according to claim 16, wherein the determining the target contestant from the contestants of the at least two teams respectively based on the role selection data and the role selection information of the contestant comprises:
sorting virtual roles selected for the contestants in the at least two teams respectively based on a role selection frequency in the role selection data to obtain a role order corresponding to the at least two teams respectively; and
determining the target contestant corresponding to the team from the at least two teams based on the role order.

18. The computer device according to claim 12, wherein the displaying, in response to the target event being in a livestreaming status, an event pop-up in the application interface comprises:
acquiring team information about at least two teams participating in the target event in response to detecting that the target event is in the livestreaming status, and event data corresponding to the current event matchup; and
generating the event pop-up based on the team information and the event data; and
displaying the event pop-up in the application interface.

19. The computer device according to claim 18, wherein the displaying contestant information about the target contestant in the event pop-up comprises:
displaying first contestant information of the target contestant in the event pop-up in response to the event data being empty, the first contestant information comprising an image identification of the target contestant and a team logo of the corresponding team of the target contestant.

20. A non-transitory computer-readable storage medium, the computer-readable storage medium storing at least one program code, the program code being loaded and executed by a processor to implement a method for displaying event pop-ups, the method comprising:
displaying an application interface in a target application, the target application having an association with a target event, the target application having a target account logged in;
displaying an event pop-up in the application interface in response to the target event being in a livestreaming status, contestants of the target event comprising a target contestant; and
displaying contestant information about the target contestant in the event pop-up, the target contestant having an interest association with the target account.
